(19) United States
(12) Patent Application Publication
(10) Pub. No.: US 2002/0133435 A1
(43) Pub. Date: Sep. 19, 2002

(54) Manufacture sale control system

(76) Inventors: Yoshiaki Ito, Chiba-shi (JP); Shoji Nakamura, Chiba-shi (JP); Yoshio Hattori, Chiba-shi (JP); Masaru Suzuki, Chiba-shi (JP); Osamu Watanabe, Chiba-shi (JP); Yasuhiro Matsukawa, Chiba-shi (JP)

Correspondence Address: ADAMS & WILKS, ATTORNEY AND COUNSELORS AT LAW, 31st FLOOR, 50 BROADWAY, NEW YORK, NY, 10004, US

(21) Appl. No.: 09/919,415

(22) Filed: Jul. 31, 2001

Related U.S. Application Data
(60) Provisional application No. 60/221,788, filed on Jul. 31, 2000.

(51) Int. Cl. G06F 17/60

(52) U.S. Cl. 705/28; 705/26

(57) ABSTRACT

Having master database respectively with the order information that forecast, the one for rank of the unofficial notification, the decision have the system of Sales Department gate about each list of articles, and the input turn information.

Transfer business stock information to the production control system of the factory automatically at night. As for the factory, compute a production plan automatically transfer a factory shipping answer to the system of Sales Department gate automatically. As for the system of Sales Department gate. It replies it to automatic profit the client in the time limit of delivery toward each order information of the time limit of delivery.

### BACKGROUND OF THE INVENTION

This invention broadly concerned with manufacture sale control system and collected order information transmitted to the factory and furthermore the number of the new injection is calculated from the order information, the stock information, details do the point quantity calculation, ex. within 24 hours from the order, copes with it flexibly. Moreover, the one with business is done automatically, and the shipping information of the factory is related to the manufacture sale control system which takes out directions for shipping automatically toward the fixed order.

FIG. 2 is a conventional production sale control system. A sales person 202 transmit order information from the client 201 to order representative 203, and order person 203 order to a production control person 204 of the factory from the stock conditions and experience. As for the production control person 204 of the factory take both a device and factory stock into consideration with the information, calculate the amount of the place point, make a production plan.

It replied to the business (answer) person 205 who took charge of a time limit of delivery answer as a factory time limit of delivery, and a time limit of delivery answer was being done through the business person 202 to the client. Then, as for shipping of the product The business (shipping) person 206 who takes charge of shipping checks shipping information (arrival of goods information to the business such as the quantity of the product) from the factory. Moreover, it is totaled in the moon unit, order it to the factory, make a production plan, order information is the system of the monthly cycle that a time limit of delivery answer is done

Each information had an electronic medium to every fixed period, and it was there, and it was the off-line system which disposed of data between each factory and Sales Department gate.

On the other hand, each factory had business flow of arrangement for a factory, a system from the order which was suitable for manufacturing each product, and employed independent database and a system respectively inside each factory and Sales Department gate. Then, as for the control system of each business body (Sales Department gate) and this society meter system. Each was another system, and it was employed off-line.

However, it had the following problem with the above-mentioned system. In other words, because the business charge, the business (order answer) pass in the plural with the charge, the production control charge, and so on. Increase quantity, days, a margin such as a time limit of delivery with each charge, order information is processed

Before a production plan is made from the original order information, when it takes time and time, together And, because it is employed respectively with independent database and the system, from the difference such as data, the head of each database of the system of each factory and Sales Department gate who defines it and who means it. The transmission of the information by the person, compensation, a complement become necessary. Difference occurs in the order information, the production plan, the stock information. The meaning of data is mistaken in the factory side and the business side. The correctness of the information, sureness were spoilt, and it had the subject that it lacked speedily of the information transmission.

Then, each factory had business flow of arrangement for a factory, a system from each order though each product was manufactured, and therefore each factory and Sales Department gate employed independent database and a system respectively. In other words, because it is more than one system that Sales Department gate is different from each factory. Connect each directly over the network. Transmit the order information of Sales Department gate directly to the system of the factory.

It replies it in the production plan, the factory time limit of delivery, the manufacture sale control system that it replies it to the client in the time limit of delivery can't be made easily It had the subject that many expenses and talented people became necessary as to employment, control, the aspect of maintenance support.

Therefore collect order information in months to order it to the factory and to do a time limit of delivery answer through the production plan, toward the increase and decrease information of the order, in such cases correction such as the stocking plan of the business, the production plan of the factory To order it to the factory and to do a time limit of delivery answer through the production plan, toward the increase and decrease information of the order, in such cases correction such as the stocking plan of the business, the production correction of the plan, and it can't be done easily and rapidly

And, when a business (answer) charge is absence. Even if a time limit of delivery answer comes from the factory, a time limit of delivery answer isn't done timely to the client. Or, take margin, for example, 3-5 days, beyond the necessity toward the factory time limit of delivery answer. Or, it had the subject that it replied it the quantity beyond the number of the factory time limit of delivery answers. Then, as for shipping of the product. The business (shipping) charge who takes charge of shipping checks shipping information (arrival of goods information to the business such as the quantity of the product) from the factory.

To take out directions for shipping toward the fixed order. The case that it isn't considerate even if a product is shipped a little early from the factory. When a business (shipping) charge is absence, check, direction for delay shipping are delayed Or, without a fixed order, it had the subject that directions for shipping could be taken out by accident. Transmit order information precisely rapidly by the made thing in view of the done above-mentioned problem, as for this invention, raise the transparency of the information When duplicate work is stopped, together, from the order, even a time limit of delivery answer, for a short period of time (for example, within 24 hours), and it can cope with it flexibly Moreover, the one with business the shipping information of the factory automatically, and aims at providing the manufacture sale control system which can take out directions for shipping automatically toward the fixed order.

### BRIEF DESCRIPTION OF THE DRAWINGS

FIG. 1 is a manufacture sale control system flow diagram of the present invention,

FIG. 2 is a manufacture sale control system flow diagram,

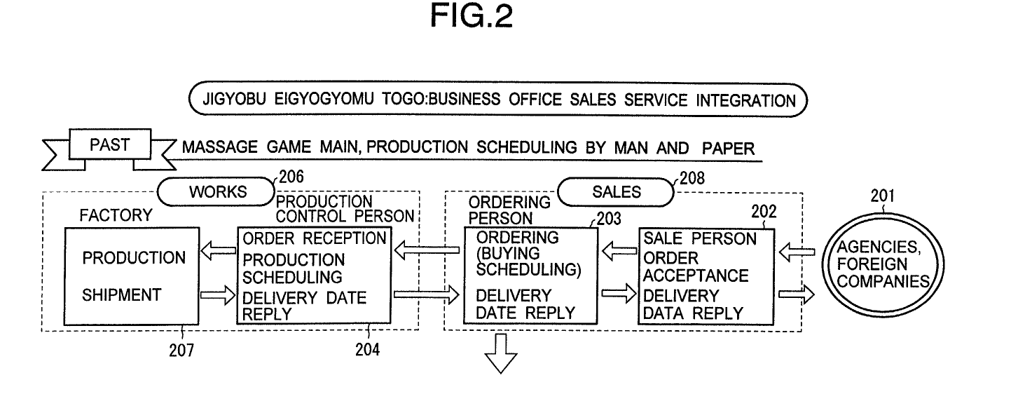

FIG. 3 is a manufacture sale control system data flow of the present invention,

FIG. 4 is a system diagram of the present invention,

FIG. 5 is a flow chart from order to reply of the present invention,

FIG. 6 is an input screen of the present invention,

FIG. 7 is an output screen of the present invention, and

FIG. 8 is a flow chart of shipping of the present invention.

### SUMMARY OF THE INVENTION

To attain the above purpose as for the manufacture sale control system concerned with this invention. With the means that give rank information it about each list of articles and input order information. With serial number grant means that an order serial number is given to the above order information With the stock control means that the memory means that the above order information and the above order serial number are memorized, and the stock information of each above list of articles are managed. With the means which transmits the above order information and the above order serial number and the above stock information to the system on the manufacture person side.

When the number of the new injection is calculated with the computer from the above order information, the above stock information and the stock information on the manufacture person side, with the point quantity calculation means With the production plan means that a production plan is made. From the above production plan, manufacture person side shipping information such as [symbol] up quantity of each above list of articles and [symbol] up date, with the manufacture person side time limit of delivery answer means which it replies to

From the above production plan, manufacture person side shipping information such as [symbol] up quantity of each above list of articles and [symbol] up date, with the manufacture person side time limit of delivery answer means which it replies to

With the means which transmits the above manufacture person side time limit of delivery answer to the system on the order information sending person side.

In accordance with the fixed method

With a time limit of delivery answer means that [symbol] up quantity of each above list of articles is deducted in the above order serial number and to put. Make that it consists of master database means of each which the place of the order, the place of the request, a payment person, a business staff (employee), master code such as a list of articles were unified to characteristics.

As for the above rank information.

They are forecast, either unofficial notification or decision out of three ranks.

From forecast, to the unofficial notification Or, from forecast, to the decision Or, make that it depends on a degree of order from the unofficial notification to the decision and it can be changed characteristics.

Make that you transmit the above order information and the above order serial number and the above stock information to the system of the factory (manufacture person side) in every fixed time characteristics.

Make that you transmit the above manufacture person side time limit of delivery answer (factory time limit of delivery answer) to the system on the order information sending person side (control of a sale) in every fixed time characteristics.

As for the method of the above place.

Make that it is a time limit of delivery answer means that up quantity of each above list of articles is deducted in the above order serial number of the order and to put characteristics.

### DETAILED DESCRIPTION OF THE PREFERRED EMBODIMENTS

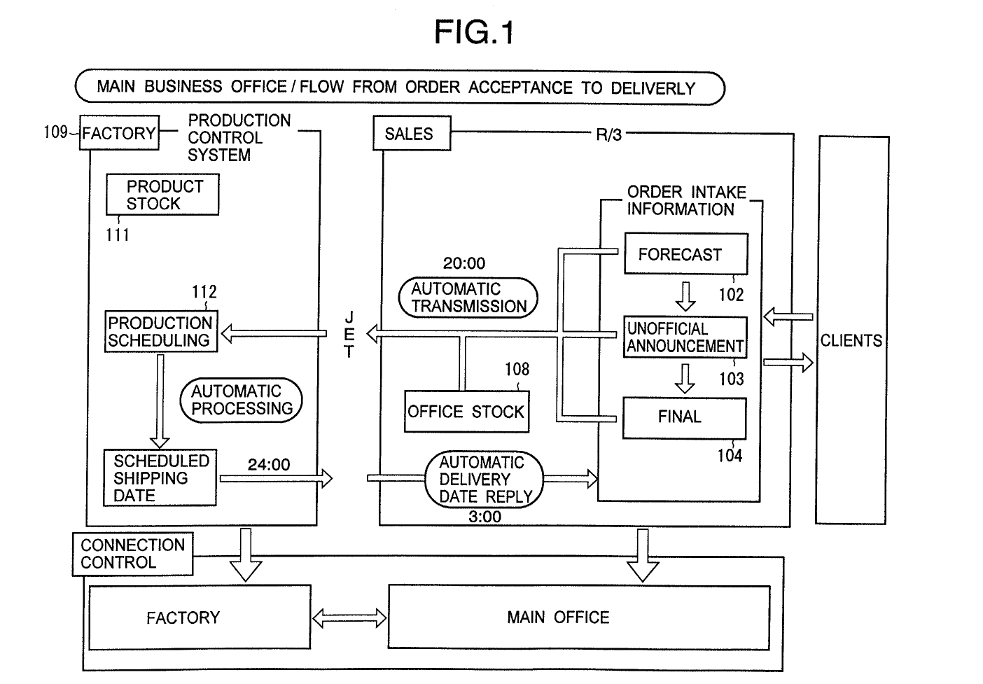

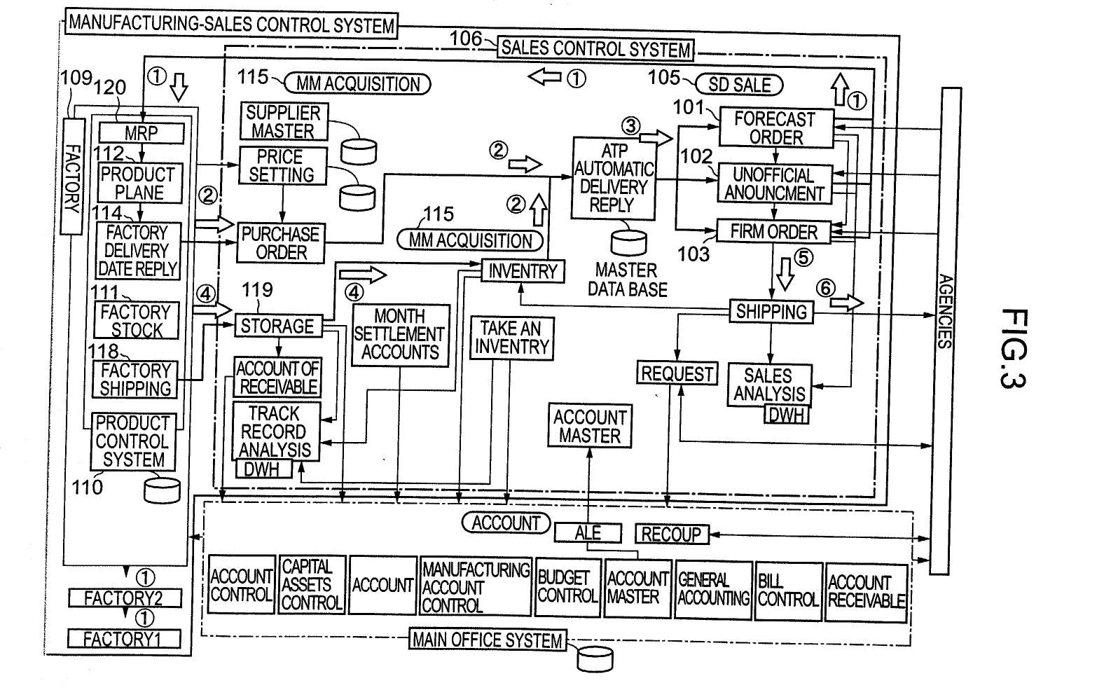

This invention will be described in further detail by way of example with reference to the accompanying drawings. FIG. 1 is the outline figure of data flow of the manufacture sale control system which shows an example of this invention. FIG. 3 is flow of data of the details figure of dataflow of the manufacture sale control system which shows an example of this invention.

(1) A sale person divides order information 101 such as list of articles, quantity, time limit of delivery into 3-steps rank of forecast 102 unofficial notification 103, final 104, and input to SD (Sales and Distribution : sale control modules) 105 of the sale control system 106 of Sales Department. Serial number that automatic serial number has a system at the time of the input is given and memorized together with the order information in database of the sale control system 106.

(2) The serial number that it is given automatically, order information 101, business stock information 108 transfer to the manufacture control system 110 of a factory 109 to manufacture a list of articles to apply automatically every day in the fixed time (for example, 20:00).

(3) In the factory 109 based on the information, the manufacture control system 110 of the factory carry out MRP, Material Requirements Planning: material place point quantity plan, 120, and calculate a new introduce required amount about each list of articles from factory stock information 111, such as order information 101, business stock information 108 and in-process item.

(4) Make a production plan 112 automatically from MRP 120 to the fixed period point, for example, at least 3-month point.

(5) Make the quantity of each list of articles, factory time limit of delivery information 114 such as a shipping expected date of confinement automatically further from the production plan 112.

(6) Transfer it to the sale control system 106 of Sales Department gate automatically as a factory time limit of delivery answer 114, ex. 3:00 at the same night for example.

(7) With the sale control system 106 of Sales Department gate which a factory time limit of delivery answer 114 was taken in MM (Material Management stock purchase control module115 as purchase order remainder, and memorize it in database

(8) Based on the factory time limit of delivery answer 114 and the business stock information 108, ATP, Available To Promise : An automatic time limit of delivery answer module or Reschedule, 116 plan into action and make a time limit of delivery answer 117 automatically against factory time limit of delivery 114. the logic (that carry out fixed )116 that it is named as Reschedule and it faces a factory time limit of delivery answer 114, for example, business stock and warehousing schedule. It makes a time limit of delivery answer 117 automatically with) to pull the early order of the order information, forecast in order that it was inputted and to put it for each order the factory time limit of delivery answer. In other words, carry it out here in the fixed period 20 o'clock for example order information production control system 110 each factory automatically transfer day about 9 o'clock next day from the input of the order information 101 to the time limit of delivery answer 117.

If order information 101 is registered in the sale control system 106 of Sales Department gate, a time limit of delivery corresponding to the production plan 112 of the factory 109 each is shown automatically in the morning on the next day, and it can reply to the client by this. Therefore, as for the factory 109 each, a production plan to the fixed period point (for example, at least, 3-month point) is made automatically every day. For example, factory 109, at a case like a semiconductor factory, a production plan at the former process

The production plan of distributing Turing plan such as an inspection device in the inspection process of the semiconductor to the free device and of making an arrangement. It begins to clear it again toward the outside factory such as a processing process, and a production plan 112 to the fixed period point (for example, at least, 3-month point) is made automatically in such cases as the production plan all every day.

Dispose of (8) automatically from the above (2) in the fixed period every (for example, every day) until order remainder disappears. The order of the business comes out a change such as days addition and elimination is done, and the addition, the change, the elimination input order information 101 every time.

(9) When a product is completed at the factory 109, a factory faces Sales Department and a product is shipped. The shipping information of the factory is taken in the sale control system 106 of Sales person automatically as the one with business supply from the production control system 110 of the factory and storages in database, and business stock information 108 is renewed.

(10) There is business stock, and a sale control system 106 takes out directions for shipping automatically toward the list of articles which is a fixed order. Here, by factory shipment, factory shipping 118, = business warehousing 119, as for the business stock information 108, renewal, about, real time, is done at any time An arrangement is made automatically in the business shipping section at the night based on the number of the business stocks that it actually obtains the directions for shipping.

(11) The business shipping section person in charge of each warehouse packs arrangement for directions for shipping in the place, and ships a product.

(12) Transfer various accounting data, accounts of receivables, accounts payable, stock etc, to the head office server at night of the day as a result of doing stocking of the product and shipping it occurred.

And, the transmission of data of the sale control system 106 space of the production control system 110 of the factory 109 and Sales Department gate is carried out over the network through collection and delivery trust server 408. Here, as for 3-step rank of the order information 101 From forecast 102, to the unofficial notification 103 From forecast 102, to fixed 104

Depend on a degree of order accuracy from the unofficial notification 103 to fixed 104, and it can be changed. And, as for forecast, the order prospects that Sales Department gate anticipates it As for the decision, the order of catching an order sheet Unofficial notification is forecast or information except for the decision.

The order information of which rank can carry out capacity calculation of the factory because MRP120 is carried out with the production control system 110 of the factory as mentioned in mentioning above and a production plan 112 is made, too. A factory time limit of delivery answer 114 is made as a result in Sales Department gate.

However, it is only a list of articles based on the order information 101 of the unofficial notification 103 and fixed 104 that a production control system 110 does arrangement for automatic manufacture.

And, as for the manufacture sale control system of this invention

MRP120, a production plan 112, ATP116, (manufacture), a fixed rule, in other words

Rank of \mathring{1} order information \mathring{2} hope time limit of delivery In \mathring{3} input of the order (in automatic serial number of the order) Place in the order of priority in priority of the order of every \mathring{4} order, and each can be carried out.

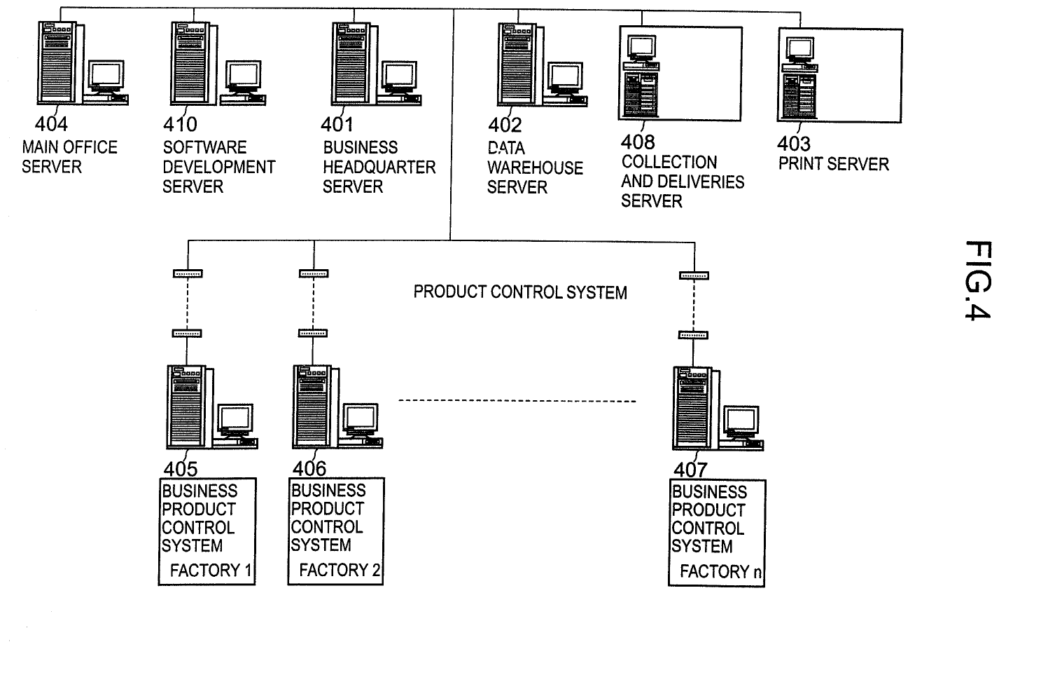

Next, explain about the composition example of hardware which becomes the base trunk system of the manufacture sale control system by using the FIG. 4. A FIG. 4 is client server system composition which connects each server with network.

It is made to deal with each function disperse with more than one server, and each server is the manufacture sale control system of the composition that it disposes of it the order from the client (for example, the user side PC).

As for data ware house server 402( dataware ;DWH for the information control of Sales Department gate, information warehouse. The database of the information or to do hypothesis verification strategically. Then, print server 403 which controls a veil vote such as a shipping directions document and a delivery note. Head office server 404 which manages account receivables of the business headquarters, account payable data.

There are production control server 405 which had a production control function in each factory, 406, 407 of each.

There are production control server 405 which had a production control function in each factory, 406, 407 of each.

It is composed of collection and delivery trust server 408 controlling the exchange of production control server 405 of each factory, 406, 407 and data in the business headquarters server 401 space have master database (for example, master database of each which the place of the order become, the place of the request, a payment person, a business staff (employee), master code such as a list of articles was unified).

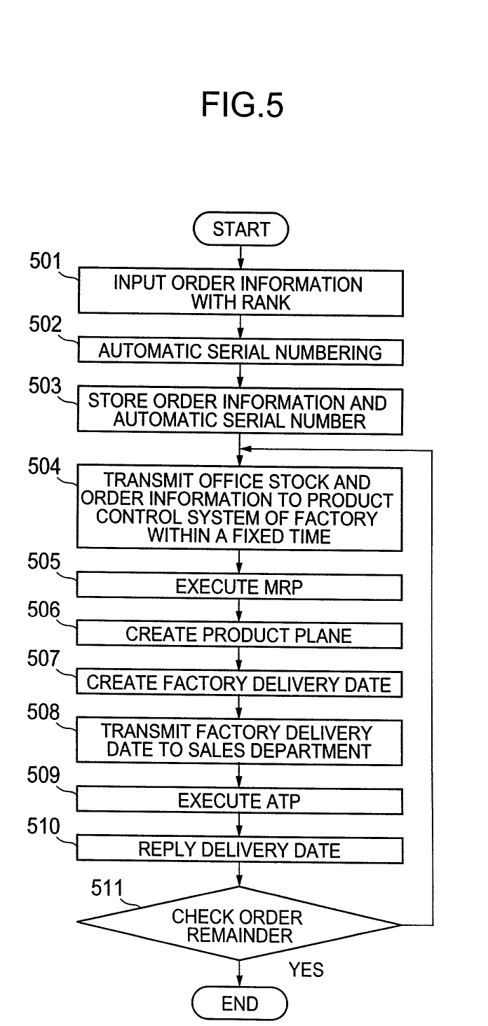

Next, FIG. 5 shows an flowchart of even the time limit of delivery answer from the order of the manufacture sale control system which shows 1 execution example of five figure invention. With the step 501 that the one with rank does order information such as a list of articles and which it is inputted from. With the step 502 which automatic serial number ranking list is a party to. with the step 504 which business stock and order information are transmitted to the production control system of the factory in the step 503 of memorizing order information and automatic serial number and the fixed time.

With the step of carrying out MRP and the step 506 of making a production plan. Factory time limit of delivery, with a step 507 to make Factory time limit of delivery, with a step 508 to transmit to the system of Sales Department gate With the step 509 of carrying out ATP. With the step 510 that it replies it in the time limit of delivery. Order remainder it consists of check steps 511 until order remainder disappears. Order remainder is shown from the step 504 which business stock and order information are transmitted to the production control system of the factory in the fixed time to be flow which repeats a check step 511 and to carry out.

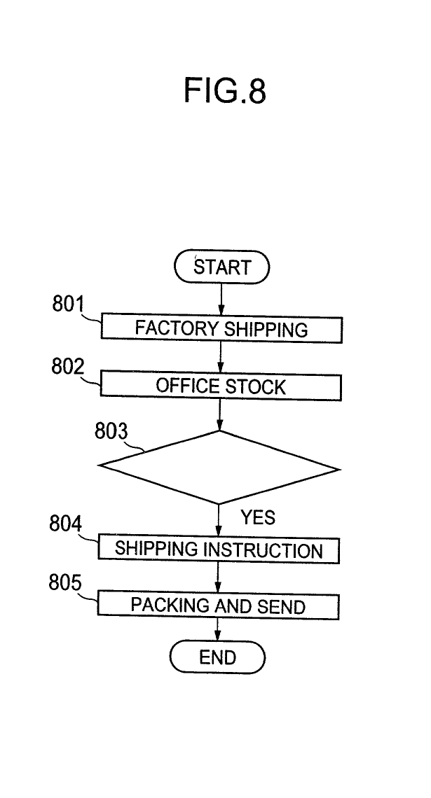

Next, FIG. 8 shows an explain outline flowchart of even shipping from factory shipping of the manufacture sale control system which shows 1 execution example of eight figure invention to the client. With the step 801 of shipping a factory. It, if it is a fixed order from a step 802 that it is stocked and to make business stock, and the order information, with the step 803 of checking whether there is business stock With the step 804 which directions for shipping are taken out from when there is business stock by the fixed order.

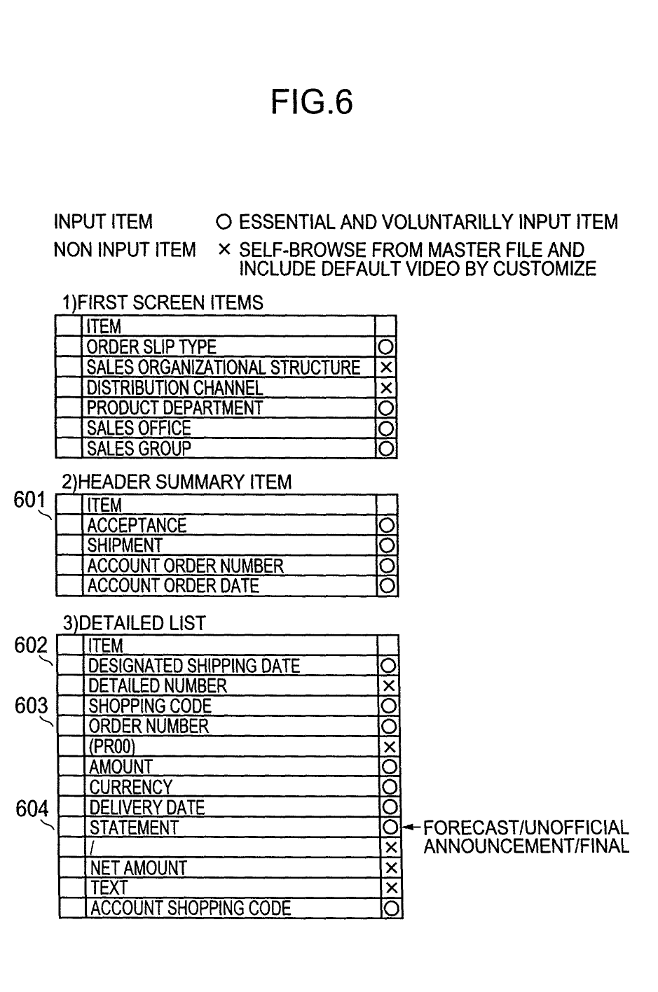

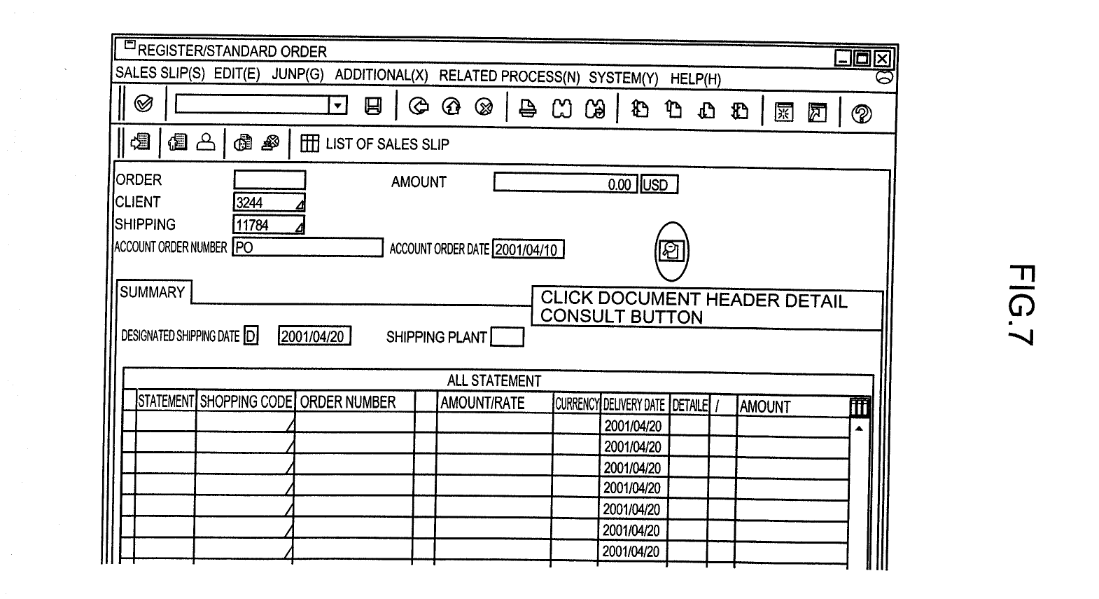

It is shown that it is flow which consists of the steps which do packing, and delivery. Next, with the example of the input item of the order information of the manufacture sale control system which shows 1 execution example of FIG. 6 invention Explain about an example of the input screen of the manufacture sale control system which shows 1 execution example of FIG. 7. Order point 601, Designated shipping date 602 (Guest point hope time limit of delivery=Sales Department start load hope day) Order quantity 603.

As for the item which the ◯ mark of details the 604 prize was given to. It is the input item which contains essential and an option. (Contain a choice from combo box.) As for details 604 it is inputted by choosing forecast 102, either of the unofficial notification 103, fixed 104 as rank of the order information 101 from combo box. It is a non-input item because it is referred to automatically from master database which gave a X mark.

By this invention. Transmit order information precisely rapidly. When the transparency of the information is raised and duplicate work is stopped, together, from the order, even a time limit of delivery answer, short time It can cope with (for example, within 24 hours). Even when many changes went into the order information due to the change in the market and so on.

It is the manufacture sale control system which can cope with it rapidly flexibly. Moreover, the one with business does the shipping information of the factory automatically, toward the fixed order the manufacture sale control system which can take out directions for shipping automatically can be provided.

What is claimed is:

1. A production sales control system comprising:
a means for giving a rank information of a shopping list to an order information having an article and inputting a number and a time limit of delivery,
a means for giving a order serial number to the order information,
a memory means for storing the order information and the order serial number,
an inventory control means for controlling an inventory information of the shopping list,
a means for transmitting the order information and the order serial number and the inventory information to a system of production side,
a means for calculating a number of introduction of new product by the order information, the inventory information and factory inventory information using a computer,
a means for making a production plan,
a factory delivery reply means for replying shipping information having a product number and finishing date from the production plane,
a transmit means for transmitting the factory inventory information to a system of order information generating side,
a delivery reply means for reserving a finished number of the shopping list to the order serial number by the factory delivery reply and the inventory information.

2. The system as claimed in claim 1 wherein the rank information is forecast.

3. The system as claimed in claim 1 wherein the rank information is option.

4. The system as claimed in claim 1 wherein the rank information is firm.

5. The system as claimed in claim 1 further comprising a transmitting means for transmitting the order information, order serial number and the inventory information at an interval.

6. The system as claimed in claim 1 wherein the factory delivery reply means transmitting the factory sipping information at an interval.

7. A method of production sales control comprising the steps of;
giving a rank information of a shopping list and inputting an order information having a an article and inputting number and a time limit of delivery,
giving a order serial number to the order information,
storing the order information and the order serial number,
transmitting the order information and the order serial number and the inventory information to a system of production side,
calculating a number of introduction of new product by the order information, the inventory information and factory inventory information using a computer,
making a production plan,
replying shipping information having a product number and finishing date from the production plane,
reserving a finished number of the shopping list to the order serial number by the factory delivery reply and the inventory information.

8. A method for using a computer facilitate a transaction between a buyer and a seller, comprising:
inputting into the computer a rank information of a shopping list and inputting an order information having a an article and inputting number and a time limit of delivery,
storing the order information and the order serial number,
transmitting the order information and the order serial number and the inventory information to a system of production side,
calculating a number of introduction of new product by the order information, the inventory information and factory inventory information using a computer,
outputting shipping information having a product number and finishing date from the production plane,
providing a finished number of the shopping list to the order serial number by the factory delivery reply and the inventory information.
